(19) United States
(12) Patent Application Publication
(10) Pub. No.: US 2022/0222306 A1
(43) Pub. Date: Jul. 14, 2022

(54) SYSTEM, METHOD AND APPARATUS FOR PRESENTING INFORMATION

(71) Applicant: Beijing Wodong Tianjun lnformation Technology Co., Ltd., Beijing (CN)

(72) Inventors: Yu LI, Beijing (CN); Guoyu YAN, Beijing (CN); Lei WU, Beijing (CN)

(21) Appl. No.: 17/606,475

(22) PCT Filed: Mar. 26, 2020
(86) PCT No.: PCT/CN2020/081320

§ 371 Date: Oct. 26, 2021

(30) Foreign Application Priority Data
Apr. 26, 2019 (CN) 201910344280.0

(51) Int. Cl. G06F 16/9535; G06F 3/04812; G06F 3/04842; G06F 16/957

(52) U.S. Cl. CPC G06F 16/9535; G06F 16/9574; G06F 3/04842; G06F 3/04812

(57) ABSTRACT

A system, a method and an apparatus for presenting information are provided. The system may include a terminal device and a first server. The terminal device is configured to send, in response to a triggering operation of a user for target information displayed on a first target interface or in response to a user login operation, a scenario information acquisition request including user information of the user to the first server; the first server is configured to acquire scenario information related to an item preferred by the user based on the user information, and return the scenario information to the terminal device; and the terminal device is further configured to present the scenario information on the first target interface.

This application claims priority of to Chinese Patent Application No. 201910344280.0, filed on Apr. 26, 2019, titled “System, Method and Apparatus for Presenting Information”, the applicant of which is Beijing Wodong Tianjun information Technology Co., Ltd. The disclosure of the application is hereby incorporated by reference in its entirety.

### TECHNICAL FIELD

Embodiments of the present disclosure relate to the field of computer technology, and specifically to a system, method and apparatus for presenting information.

### BACKGROUND

Information pushing (also called “network broadcasting”) is a technology that reduces information overload by pushing information required by users over the Internet through a certain technical standard or protocol. The information pushing technology can reduce the time a user takes to search on the Internet by actively pushing information to the user.

For the existing item-related information pushing approach, the information pushing approach generally refers to that an item the user interested in is mined, and the item information of the mined item is then presented on an Interface. For example, item information of a part of all mined items is presented at a limited presentation position on the homepage of a shopping website or of a shopping application.

### SUMMARY

Embodiments of the present disclosure propose a system, method and apparatus for presenting information.

In a first aspect, an embodiment of the present disclosure provides a system for presenting information. The system includes a terminal device and a server; the terminal device is configured to in response to a triggering operation of a user on target information displayed on a first target interface or in response to a login operation of the user, a scenario information acquisition request including user information of the user to the first server; the first server is configured to acquire scenario information related to an item preferred by the user based on the user information, and return the scenario information to the terminal device; and the terminal device is further configured to present the scenario information on the first target interface.

In some embodiments, a scenario indicated by the scenario information corresponds to at least one item category, the system further includes a second server, the terminal device is further configured to send, in response to a triggering operation of the user on the scenario information, a second target interface acquisition request including the user information to the second server, the second server is configured to acquire item information of an item preferred by the user and related to the at least one item category based on the user information, generate a second target interface based on the acquired item information, and return the second target interface to the terminal device, and the terminal device is further configured to present the second target interface to the user.

In some embodiments, the scenario information includes an animation and guide information related to the scenario indicated by the scenario information.

In some embodiments, the target information is logo information of a website or client application to which the first target interface belongs, and the animation is generated based on an image related to the logo information.

In some embodiments, the terminal device is further configured to: present the scenario information at a presentation position where the target information is located.

In some embodiments, the first server is further configured to: acquire historical behavior data of the user based on the user information; select an item identifier from a preset item identifier set based on the historical behavior data, to generate an item identifier group, where an item identifier in the item identifier set corresponds to a subject identifier, the subject identifier corresponds to an animation and at least one scenario, and each scenario in the at least one scenario corresponds to guide information; select, from a subject identifier corresponding to an item identifier in the item identifier group, a subject identifier as a target subject identifier; select, from at least one scenario corresponding to the target subject identifier, a scenario as a target scenario; and generate the scenario information including an animation corresponding to the target subject identifier and guide information corresponding to the target scenario.

In some embodiments, the historical behavior data includes at least one item identifier, and an item identifier in the at least one item identifier corresponds to a frequency; and the first server is further configured to: select an item identifier associated with the at least one item identifier from the item identifier set as a candidate item identifier, to generate a candidate item identifier set; and select a candidate item identifier satisfying a preset selection condition from the candidate item identifier set, to generate the item identifier group, the selection condition including at least one of: an item identifier being not included in a first item identifier set, or a frequency corresponding to the item identifier being not higher than a frequency threshold, where an item indicated by a first item identifier in the first item identifier set is an item prohibited from being presented.

In some embodiments, the first server is further configured to: determine a decree of preference of the user for an item indicated by a candidate item identifier in the candidate item identifier set based on the at least one item identifier, after generating the candidate item identifier set; and use a subject identifier corresponding to an item identifier corresponding to a maximum degree of preference in the item identifier group as the target subject identifier, after generating the item identifier group.

In some embodiments, the second server is further configured to: acquire a user preference model pre-established for the user based on the user information, the user preference model including an item identifier of the item preferred by the user; extract an item identifier related to the at least one item category from the user preference model; and acquire item information of an item indicated by the extracted item identifier.

In some embodiments, the second server is further configured to: generate an item information set based on the acquired item information; acquire associated information of item information in the item information set; sort pieces of the item information in the item information set based on the acquired associated information, to obtain an item information sequence; and generate the second target interface based on the item information sequence.

In some embodiments, the trigger operation includes a mouse hovering operation, a single-click operation, a double-click operation, or a sliding operation.

In some embodiments, the target information includes text or icons.

In some embodiments, the target information includes an image mark presenting a target object, the scenario information includes animation and guideline information, and at least one frame of image in the animation presents the target object, where the scenario information is triggerable information and after the scenario information is triggered, the second target interface is presented, the second target interface presenting the item information of the item preferred by the user.

In some embodiments, the terminal device is configured to present the scenario information around the target information in response to no information being presented around the target information.

In some embodiments, the terminal is configured to: in response to the user login operation, acquire the scenario information and store the scenario information in a cache; and in response to the user trigger operation on the target information, present the scenario information in the cache on the first target interface.

In the second aspect, an embodiment of the present disclosure provides a method for presenting information, which is applied to a terminal device. The method includes: sending, in response to a triggering operation of a user on target information displayed on a first target interface or in response to a login operation of the user, a scenario information acquisition request including user information of the user to a first server, to cause the first server to acquire scenario information related to an item preferred by the user based on the user information; receiving the scenario information returned by the first server; and presenting the scenario information on the first target interface.

In some embodiments, a scenario indicated by the scenario information corresponds to at least one item category, and the method includes: sending, in response to a triggering operation of the user for the scenario information, a second target interface acquisition request including the user information to a second server, to cause the second server to acquire item information of an item preferred by the user and related to the at least one item category based on the user information, and generate a second target interface based on the acquired item information; receiving the second target interface returned by the second server; and presenting the second target interface to the user.

In some embodiments, the scenario information includes an animation and guide information related to the scenario indicated by the scenario information.

In some embodiments, the target information is logo information of a website or client application to which the first target interface belongs, and the animation is generated based on an image related to the logo information.

In some embodiments, the presenting the scenario information on the first target interface includes: presenting the scenario information at a presentation position where the target information is located.

In some embodiments, the trigger operation includes a mouse hovering operation, a single-click operation, a double-click operation, or a sliding operation.

In some embodiments, the target information includes text or icons.

In some embodiments, the target information includes an image mark presenting a target object, the scenario information includes animation and guideline information, and at least one frame of image in the animation presents the target object, where the scenario information is triggerable information and after the scenario information is triggered, the second target interface is presented, the second target interface presenting the item information of the item preferred by the user.

In some embodiments, the terminal device is configured to present the scenario information around the target information in response to no information being presented around the target information.

In some embodiments, the terminal is configured to: in response to the user login operation, acquire the scenario information and store the scenario information in a cache; in response to the user trigger operation on the target information, present the scenario information in the cache on the first target interface.

In a third aspect, an embodiment of the present disclosure provides an apparatus for presenting information, which is applied to a terminal device. The apparatus includes: a first sending unit, configured to send, in response to a triggering operation of a user on target information displayed on a first target interface or in response to a login operation of the user, a scenario information acquisition request including user information of the user to a first server, to cause the first server to acquire scenario information related to an item preferred by the user based on the user information; a first receiving unit, configured to receive the scenario information returned by the first server; and a first presenting unit, configured to present the scenario information on the first target interface.

In some embodiments, a scenario indicated by the scenario information corresponds to at least one item category, and the apparatus further includes: a second sending unit, configured to send, in response to a triggering operation of the user for the scenario information, a second target interface acquisition request including the user information to a second server, to cause the second server to acquire item information of an item preferred by the user and related to the at least one item category based on the user information, and generate a second target interface based on the acquired item information; a second receiving unit, configured to receive the second target interface returned by the second server; and a second presenting unit, configured to present the second target interface to the user.

In some embodiments, the scenario information includes an animation and guide information related to the scenario indicated by the scenario information.

In some embodiments, the target information is logo information of a website or client application to which the first target interface belongs, and the animation is generated based on an image related to the logo information.

In some embodiments, the first display unit is further configured to: present the scenario information at a presentation position where the target information is located.

In some embodiments, the trigger operation includes a mouse hovering operation, a single-click operation, a double-click operation, or a sliding operation.

In some embodiments, the target information includes text or icons.

In some embodiments, the target information includes an image mark presenting a target object, the scenario information includes animation and guideline information, and at least one frame of image in the animation presents the target object, where the scenario information is triggerable information and after the scenario information is triggered, the second target interface is presented, the second target interface presenting the item information of the item preferred by the user.

In some embodiments, the terminal device is configured to present the scenario information around the target information in response to no information being presented around the target information.

In some embodiments, the terminal is configured to: in response to the user login operation, acquire the scenario information and store the scenario information in a cache; in response to the user trigger operation on the target information, present the scenario information in the cache on the first target interface.

In a fourth aspect, an embodiment of the present disclosure provides an electronic device, which includes: one or more processors; a storage device on which one or more programs are stored; where the one or more programs when executed by the one or more processors cause the one or more processors to implement the method according to any embodiment of the second aspect.

In a fifth aspect, an embodiment of the present disclosure provides a computer-readable medium on which a computer program is stored, and when the program is executed by a processor, the method as described in any embodiment of the second aspect is implemented.

According to the system, method and apparatus for presenting information provided in the above embodiments of the present disclosure, the terminal device sends, in response to the triggering operation of the user for the target information displayed on the first target interface or in response to a login operation of the user, the scenario information acquisition request including the user information of the user to the first server. Then, the first server acquires the scenario information related to the item preferred by the user based on the user information, and returns the scenario information to the terminal device, such that the terminal device presents the scenario information on the first target interface. According to the scheme described in the above embodiment of the present disclosure, the scenario information the user is interested in may be recommended by mining the interest of the user, thereby implementing that the information is pushed with more pertinence. In addition, by presenting the scenario information, the interest of the user in access may be promoted, which helps to increase the number of users.

### BRIEF DESCRIPTION OF THE DRAWINGS

After reading detailed descriptions of non-limiting embodiments given with reference to the following accompanying drawings, other features, objectives and advantages of the present disclosure will be more apparent:

FIG. 1 is a diagram of an example system architecture in which some embodiments of the present disclosure may be applied;

FIG. 2 is a timing diagram of an embodiment of a system for presenting information according to the present disclosure;

FIG. 3 is a schematic diagram of a presented scenario information;

FIG. 4 is a schematic diagram of an application scenario of the system for presenting information according to the present disclosure;

FIG. 5 is a timing diagram of another embodiment of the system for presenting information according to the present disclosure;

FIG. 6a is a schematic diagram of an information flowing process of the system for presenting information according to the present disclosure;

FIG. 6b is a schematic diagram of a product form of the system for presenting information according to the present disclosure;

FIG. 7 is a flowchart of an embodiment of a method for presenting information according to the present disclosure;

FIG. 8 is a schematic structural diagram of an embodiment of an apparatus for presenting information according to the present disclosure; and

FIG. 9 is a schematic structural diagram of a computer system of an electronic device adapted to implement some embodiments of the present disclosure.

### DETAILED DESCRIPTION OF EMBODIMENTS

The present disclosure is further described below in detail by combining the accompanying drawings and the embodiments. It may be appreciated that the specific embodiments described herein are merely used for explaining the relevant invention, rather than limiting the invention. In addition, it should also be noted that, for ease of description, only the parts related to the relevant invention are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

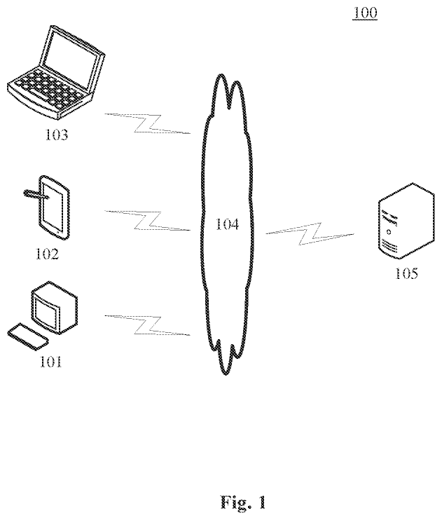

FIG. 1 illustrates an example system architecture 100 in which an embodiment of a method for presenting information or an apparatus for presenting information according to the present disclosure may be applied.

As shown in FIG. 1, the system architecture 100 may include terminal devices 101, 102 and 103, a network 104, and a first server 105. The network 104 serves as a medium providing a communication link between the terminal devices 101, 102 and 103 and the first server 105. The network 104 may include various types of connections, for example, wired or wireless communication links, or optical fiber cables.

A user may use the terminal devices 101, 102 and 103 to interact with the first server 105 via the network 104 to receive or send a message, etc. Various communication client applications (e.g., a webpage browser application and a shopping application) may be installed on the terminal devices 101, 102 and 103. The terminal devices 101, 102 and 103 may perform corresponding processing in response to a triggering operation of the user on target information displayed on a first target interface (e.g., the home page of a shopping website or a shopping application).

The terminal devices 101, 102 and 103 may be hardware or software. When being the hardware, the terminal devices 101, 102 and 103 may be various electronic devices, the electronic devices including, but not limited to, a smartphone, a tablet computer, a laptop portable computer, a desktop computer, etc. When being the software, the terminal devices 101, 102 and 103 may be installed in the above listed electronic devices. The terminal devices may be implemented as a plurality of pieces of software or a plurality of software modules (e.g., software or software modules for providing a distributed service), or as a single piece of software or a single software module, which will not be specifically defined here.

The first server 105 may be a server providing various services, for example, a backend server providing support for a website or client application to which the first target interface belongs. The backend server may receive a scenario information acquisition request sent by the terminal devices 101, 102 and 103, perform corresponding processing on the request, and return the processing result (e.g., acquired scenario information) to the terminal devices.

It should be noted that the method for presenting information provided by some embodiments of the present disclosure is generally performed by the terminal devices 101, 102 and 103. Correspondingly, the apparatus for presenting information is generally provided in the terminal devices 101, 102 and 103.

It should be noted that the server may be hardware or software. When being the hardware, the server may be implemented as a distributed server cluster composed of a plurality of servers, or as a single server. When being the software, the server may be implemented as a plurality of pieces of software or a plurality of software modules (e.g., software or software modules for providing a distributed service), or as a single piece of software or a single software module, which will not be specifically defined here.

It should be appreciated that the numbers of the terminal devices, the networks, and the first servers in FIG. 1 are merely illustrative. Any number of terminal devices, networks, and first servers may be provided based on actual requirements.

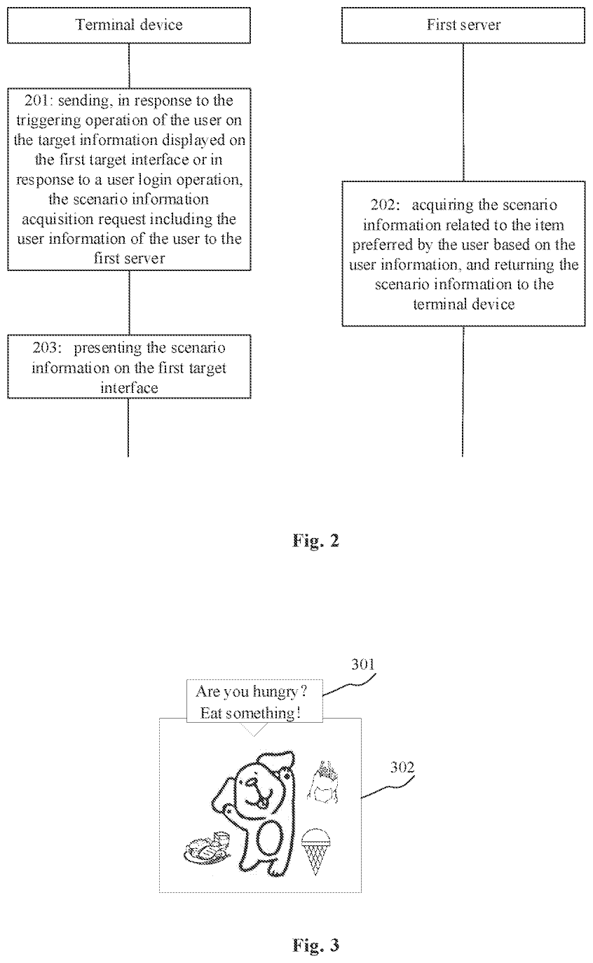

Further referring to FIG. 2, FIG. 2 illustrates a timing diagram of an embodiment of a system for presenting information according to the present disclosure.

The system for presenting information in this embodiment may include a terminal device and a first server. In some implementations of this embodiment, the terminal device is configured to send, in response to a triggering operation of a user on target information displayed on a first target interface, a scenario information acquisition request including user information of the user to the first server. The first server is configured to acquire scenario information related to an item preferred by the user based on the user information, and return the scenario information to the terminal device. The terminal device is further configured to present the scenario information on the first target interface. In other implementations of this embodiment, the terminal device is configured to send a scenario information acquisition request including user information of he user to the first server in response to the user login operation; the first server is configured to be based on the user information, acquiring scenario information related to an item preferred by the user, and returning the scenario information to the terminal device; the terminal device is also configured to store the scenario information in a cache, in response to a trigger operation of the user on the first target interface, presenting the scenario information in the cache on the first target interface

As shown in FIG. 2, in step 201, the terminal device sends, in response to the triggering operation of the user on the target information displayed on the first target interface or in response to a user login operation, the scenario information acquisition request including the user information of the user to the first server.

In this embodiment, in response to the triggering operation of the user on the target information displayed on the first target interface or in response to the user login operation, the terminal device (e.g., the terminal devices 101, 102 and 103 shown in FIG. 1) may send the scenario information acquisition request including the user information of the user to the first server (e.g., the first server 105 shown in FIG. 1). Here, the first target interface may be, for example, the home page of a specified shopping website or shopping application.

The first target interface may present many kinds of information, for example, item information, promotion information related to an item, and logo information of a website or client application to which the first target interface belongs. The target information may be any one of the many kinds of information. Here, the logo information may be used co represent the website or client application to which the first target interface belongs. The logo information may include, for example, an image and/or a text.

In this embodiment, the triggering operation of the user on the target information may be a mouse hover operation, a single-click operation, a double-click operation, a sliding operation, or the like. The user information may include, for example, basic information of the user, and the basic information may include, but not limited to, the user identifier, the age, the gender, etc. of the user.

In some implementations of this embodiment, the user login operation includes: the user logging into an application, the user logging into a webpage, or jumping to a target page.

In some implementations of this embodiment, the terminal is configured to acquire the scenario information and store the scenario information in a cache in response to the user login operation.

Here, the scenario information requested by the scenario information acquisition request may be the scenario information determined according to the item preferred by the user. In addition, the scenario information may be triggerable information. Further, the scenario information may be information triggerable and having a dynamic effect. The scenario information may include, for example, at least one of an animation or guide information. In addition, for example, the scenario indicated by the scenario information may include, but not limited to, sports, a gifted children, examination necessities, online learning, and the like.

The scenario may be pre-determined by clustering a large number of items. The scenario may correspond to guide information and at least one item category. The guide information may be used to guide the user to enter, by triggering the scenario information, a second target interface for displaying item information of an item that is under at least one item category corresponding to a scenario indicated by triggered scenario information and that is preferred by the user. For example, the second target interface may be referred to as a treasure hunt channel or a treasure hunt interface. It should be noted that the at least one item category corresponding to the scenario may be a category of a specified level (e.g., a third level). For example, a shuttlecock, a football, sports shoes, etc. under the category of the third level may be classified into the sports scenario. As another example, the following categories or the third level may be classified into the gifted children scenario: study room supplies/stationery, children literature, student stationery, a popular science encyclopedia, a children study table/chair, a smart watch, a picture book, and a desk lamp.

In step 202, the first server acquires the scenario information related to the item preferred by the user based on the user information, and returns the scenario information to the terminal device.

In this embodiment, the first server may acquire the scenario information related to the item preferred by the user based on the user information, and return the scenario information to the terminal device.

As an example, the first server may acquire a recorded scenario information pushing record related to the user information. Here, the scenario information pushing record may include, for example, an information identifier of scenario information that is already pushed to the user. In addition, the scenario information that is already pushed to the user may be determined based on the item preferred by the user. If the first server acquires the scenario information pushing record, an information identifier may be selected from the scenario information pushing record, for example, an information identifier may be randomly selected, or an information identifier having a highest frequency of occurrence may be selected. Then, the first server may acquire the scenario information indicated by the selected information identifier from a stored scenario information set.

As another example, each scenario may also correspond to an animation in advance. The animation may be generated based on an image related to the scenario. The scenario information pushing record may include, for example, an information identifier of a scenario indicated by scenario information that is already pushed to the user. If the first server acquires the scenario information pushing record, an information identifier may be selected from the scenario information push record, for example, an information identifier may be randomly selected, or an information identifier having a highest frequency of occurrence may be selected. Then, the first server may generate the scenario information including the animation and/or guide information corresponding to the scenario indicated by the selected scenario identifier.

In step 203, the terminal device presents the scenario information on the first target interface.

In this embodiment, after receiving the scenario information returned by the first server, the terminal device may present the received scenario information on the first target interface. Here, for example, the terminal device may present the scenario information at any presentation position on the first target interface. Alternatively, the terminal device may also present the scenario information at a presentation position where the triggered target information is located.

In some alternative implementations of this embodiment, the scenario information may include the animation and guide information related to the scenario indicated by the scenario information. In addition, each scenario may correspond a subject identifier in advance. One subject identifier may correspond to an animation and at least one scenario. The animation related to the scenario may be an animation corresponding to a subject identifier corresponding to the scenario. It should be noted that the subject indicated by the subject identifier may be obtained by clustering a plurality of scenarios.

In some alternative implementations of this embodiment, the target information may be the logo information of the website or client application to which the first target interface belongs. The animation may be generated based on an image related to the logo information. As an example, it is assumed that the logo information includes an image logo presenting a target object (e.g., a deg), at least one frame of image in the animation included in the scenario, information may also present the target object. Here, it is assumed that the target object is the dog, the scenario indicated by the scenario information acquired in step 202 is a food ordering scenario, and the guide information corresponding to the scenario is “Hungry! Come to order some delicious food!” For example, the final presentation effect of the scenario information that is presented by the terminal device may be as shown in FIG. 3. Here, the information pointed by the numeral 301 the guide information. The image pointed by the numeral 302 is the last frame of image in the animation included in the scenario information.

In some optional implementations of this embodiment, the terminal is configured to present the scenario information in the cache on the first target interface in response to a trigger operation of the user on the target information.

In some optional implementations of this embodiment, the terminal is configured to present the scenario information around the target information in response to no information being presented around the target information.

It should be noted that, by presenting, in response to a triggering operation of the user on the logo information or in response to a user login operation, corresponding scenario information including the animation generated based on the image related to the logo information to the user, a logo image may be dynamized and personalized on the basis that the high-quality item and content are precisely recommended in combination with the personalized demand of the user. The logo image may be vividly and stereoscopically presented to the user by means of a specified interaction. In this way, the interest of the user in accessing is promoted, and the pleasure and curiosity 171 shopping are increased, which helps to increase the number of users.

In some alternative implementations of this embodiment, in step 202, the first server may acquire, by adopting the following steps, the scenario information related to the item preferred by the user based on the user information.

First, the first server may acquire historical behavior data of the user based on the user information. The user information may include the user identifier. The user identifier and the historical behavior data maybe associated and stored in advance. Based on the user identifier, the first server may acquire the historical behavior data of the user locally or from a device connected with the first server and used to store information. The historical behavior data may include, for example, at least one item identifier. The at least one item identifier may include an item identifier respectively corresponding to at least one of the following operations of the user: browsing, an addition to a shopping cart, a query, a click, purchasing, etc. In addition, the item identifier in the at least one item identifier may correspond to a frequency.

Then, the first server may select an item identifier from a preset item identifier set based on the historical behavior data, to generate an item identifier group. Here, an item identifier in the item identifier set may correspond to a subject identifier. The subject identifier may correspond to an animation and at least one scenario. Each scenario in the at least one scenario may correspond to guide information. As an example, the first server may select an item identifier associated with the above at least one item identifier from the item identifier set as a candidate item identified, to generate a candidate item identifier set. For example, the first server may select, from the item identifier set, an item identifier satisfying any of the following conditions as the candidate item identifier: an item identifier included in the at least one item identifier, and an item identifier belonging to the same category as the item identifier in the at least one item identifier. Then, the first server may select a candidate item identifier satisfying a preset selection condition from the candidate item identifier set, to generate the item identifier group. Here, the selection condition may include at least one of: an item identifier being not included in a first item identifier set, or a frequency corresponding to an item identifier being not higher than a frequency threshold. It should be noted that an item indicated by a first item identifier in the first item identifier set may be an item prohibited from being presented.

Afterwards, the first server may select, from a subject identifier corresponding to an item identifier in the item identifier group, a subject identifier as a target subject identifier. As an example, the first server may randomly select an item identifier from the item identifier group, and use the subject identifier corresponding to the item identifier as the target subject identifier. As another example, in order to improve the accuracy of the determined target subject identifier, after generating the candidate item identifier set, the first server may determine a degree of preference of the user for an item indicated by a candidate item identifier in the candidate item identifier set, based on the at least one item identifier. After generating the item identifier group, the first server may use a subject identifier corresponding to an item identifier corresponding to a maximum degree of preference in the item identifier group as the target subject identifier. Here, a target prediction model for predicting the item preferred by the user may be run on the first server. The first server may acquire item information pieces of the item respectively indicated by candidate item identifiers in the candidate item identifier set. Then, the first server may input the above at least one item identifier and the acquired item information into the target prediction model to obtain a prediction result. The prediction result may include the degree of preference of the user for the item indicated by the candidate item identifier in the candidate item identifier set. The degree of preference may refer to a value within [0, 1]. It should be noted that the target prediction model may be trained and obtained by using a model such as a Naive Bayesian Model (NBM), a Support Vector Machine (SVM), XGBoost (eXtreme Gradient Boosting), or a CNN (Convolutional Neural Network).

Then, the first server may select, from at least one scenario corresponding to the target subject identifier, a a scenario as a target scenario. For example, the first server may randomly select a scenario from the at least one scenario as the target scenario. The first server may alternatively select, from the at least one scenario, a scenario recommended to the user most times as the target scenario.

Finally, the first server may generate scenario information including an animation corresponding to the target subject identifier and guide information corresponding to the target scenario.

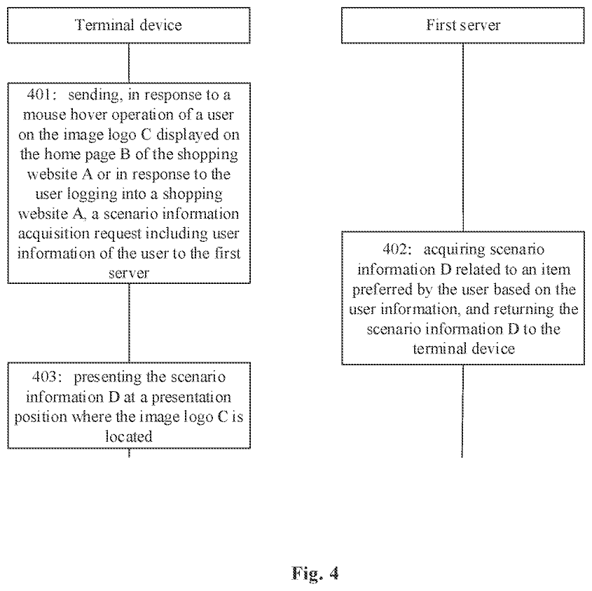

Further referring to FIG. 4, FIG. 4 is a schematic diagram of an application scenario of the system for presenting information according to this embodiment. In the application scenario of FIG. 4, the system may include a terminal device and a first server. The terminal device may display a home page B of a shopping website A. The home page B displays an image logo C of the shopping website A. As shown by the numeral 401, the terminal device may send, in response to a mouse hover operation of a user on the image logo C displayed on the home page B of the shopping website A or in response to the user logging into a shopping website A, a scenario information acquisition request including user information of the user to the first server. Then, as shown by the numeral 402, the first server may acquire scenario information D related to an item preferred by the user based on the user information, and return the scenario information D to the terminal device. Here, the scenario information D may be triggerable information. The scenario information D may include guide information corresponding to the scenario indicated by the scenario information D. The guide information may be used to guide the user to enter, by triggering the scenario information D, a corresponding treasure hunt channel. The treasure hunt channel may be used to display the item information of an item that is under at least one item category corresponding to the scenario indicated by the scenario information D and that is preferred by the user. Then, as shown by the numeral 403, the terminal device may present the scenario information D at a presentation position where the image logo C is located. In this way, when being interested in the scenario information D, the user may enter, by triggering the scenario information 10, the corresponding treasure hunt channel to browse the information of the item the user is interested in,

According to the system provided in the above embodiment of the present disclosure, the terminal device sends, in response to the triggering operation of the user on the target information displayed on the first target interface, the scenario information acquisition request including the user information of the user to the first server. Then, the first server acquires the scenario information related to the item preferred by the user based on the user information, and return the scenario information to the terminal device, such that the terminal device presents the scenario information on the first target interface. According to the scheme described in the above embodiment of the present disclosure, the scenario information the user is interested in may be recommended by mining the interest of the user, thereby implementing that the information is pushed with pertinence. In addition, by presenting the scenario information, the interest of the user in access may be promoted, which helps to increase the number of users.

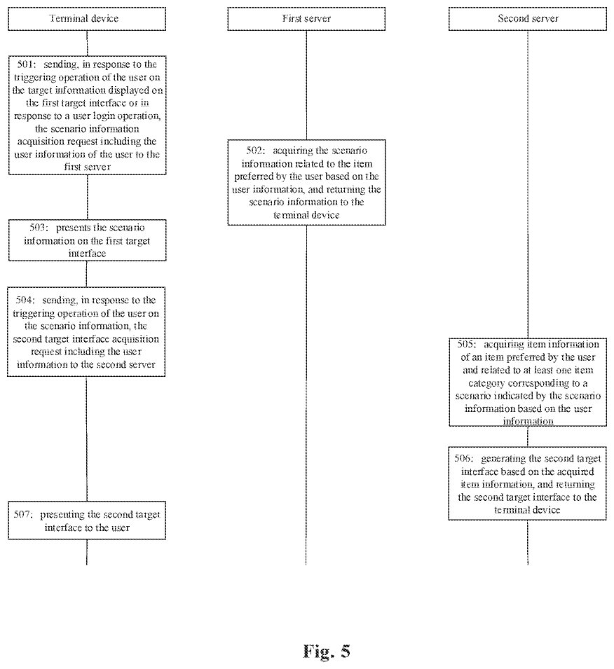

Further referring to FIG. 5, FIG. 5 illustrates a timing diagram of another embodiment of the system for presenting information according to the present disclosure.

The system for presenting information in this embodiment may include a terminal device, a first server and a second server. In some implementations of this embodiment, the terminal device is configured to send, in response to a triggering operation of a user on target information displayed on a first target interface, a scenario information acquisition request including user information of the user to the first server. The first server is configured to acquire scenario information related to an item preferred by the user based on the user information, and return the scenario information to the terminal device. The terminal device is further configured to present the scenario information on the first target interface, and send, in response to a triggering operation of the user on the scenario information, a second target interface acquisition request including the user information to the second server. The second server is configured to acquire item information of an item preferred by the user and related to at least one item category based on the user information, generate a second target interface based on the acquired item information, and return the second target interface to the terminal device. The terminal device is further configured to present the second target interface to the user. In other implementations of this embodiment, the terminal device is configured to send a scenario information acquisition request including user information of the user to the first server in response to the user login operation; the first server is configured to be based on the user information, acquire scenario information related to the item preferred by the user, and return the scenario information to the terminal device; the terminal device is also configured to store the scenario information in a cache, and in response to a trigger operation of the user on the target information in the first target interface, present the scenario information in the cache on the first target interface, and in response to the triggering operation of the user on the scenario information, send a second target interface acquisition request including the user information to the second server; the second server, is configured to acquire item information of an item related to at least one item category preferred by the user based on the user information, generate a second target interface based on the acquired item information, and return the second target interface to the terminal device; and the terminal device is further configured to present the second target interface to the user.

As shown in FIG. 5, in step 501, the terminal device sends, in response to the triggering operation of the user on the target information displayed on the first target interface or in response to a user login operation, the scenario information acquisition request including the user information of the user to the first server.

In step 502, the first server acquires the scenario information related to the item preferred by the user based on the user information, and returns the scenario information to the terminal device.

In step 503, the terminal device presents the scenario information on the first target interface.

In this embodiment, for the explanations of steps 501-503, reference may be made to the relative descriptions of steps 201-203 in the embodiment shown in FIG. 2, which will not be repeatedly described here.

In step 504, the terminal device sends, in response to the triggering operation of the user on the scenario information, the second target interface acquisition request including the user information to the second server.

In this embodiment, the terminal device (e.g., the terminal devices 101, 102 and 103 shown in FIG. 1) may send, in response to the triggering operation of the user on the scenario information, the second target interface acquisition request including the user information to the second server. Here, the triggering operation of the user on the scenario information may be a single-click operation, a double-click operation, a sliding operation, or the like. The second target interface acquisition request may further include a scenario identifier of a scenario indicated by the triggered scenario information, and the like.

It should be noted that the second server and the first server may be a given server or different servers, which will not be specifically defined here.

In step 505, the second server acquires item information of an item preferred by the user and related to at least one item category corresponding to a scenario indicated by the scenario information based on the user information.

In this embodiment, the scenario indicated by the scenario information corresponds to the at least one item category. By adopting various recommendation algorithms, the second server may acquire the item information of the item preferred by the user and related to the above at least one item category based on the user information.

As an example, the user information may include the gender and age of the user. The second server may first acquire an item identifier set formed of an item identifier of an item under the at least one item category. Here, the item identifier may correspond to a gender and an age range. The second server may remove, from the item identifier set, an item identifier satisfying at least one of: the corresponding gender being different from the gender of the user, or the corresponding age range not including the age of the user. Then, the second server may determine an item indicated by a remaining item identifier in the item identifier set as the item preferred by the user, and acquire item information of the item.

As another example, the second server may acquire a user preference model pre-established for the user, based on the user information. Here, the user preference model may include an item identifier of the item preferred by the user. Then, the second server may extract an item identifier related to the at least one item category from the user preference model. Afterwards, the second server may acquire item information of an item indicated by the extracted item identifier.

Here, the user preference model may be a model obtained by calculation based on a constructed characteristic matrix and a constructed user preference matrix. The characteristic matrix and the user preference matrix are constructed based on related data of a user. The related data includes basic information and historical behavior data of the user. The historical behavior data may include data related to at least one of the following operations of the user: browsing, an addition to a shopping cart, a query, a click, purchasing, etc. Specifically, the historical behavior data may include an item identifier respectively corresponding to the at least one operation. When the user preference matrix is constructed, a weight corresponding to each operation in the at least one operation may be appointed.

In step 506, the second server generates the second target interface based on the acquired item information, and returns the second target interface to the terminal a device.

In this embodiment, the second server may use the acquired item information as the interface content of the second target interface, thereby generating the second target interface.

In some alternative implementations of this embodiment, the second server may generate the second target interface by: generating an item information set based on the acquired item information; acquiring associated information of item information in the item information set; sorting the item information in the item information set based on the acquired associated information, to obtain an item information sequence; and generating the second target interface based on the item information sequence. Here, the associated information of the item information may include, but not limited to, popularity, revenue, amount of praise, and frequency of visits that correspond to the item indicated by the item information, and the promotion needs of the customers to whom the item belongs, etc. For example, the second server may set sorting values for pieces of the item information based on the association information. Then, the second server may sort the pieces of item information in the item information set in a descending order of the sorting values, to obtain the item information sequence.

In some alternative implementations of this embodiment, the scenario may also correspond to a background and a style. When generating the second target interface, the second server may apply the background and style corresponding to the scenario indicated by the triggered scenario information to the second target interface, to realize the generation of a personalized interface.

In step 507, the terminal device presents the second target interface to the user.

In this embodiment, the terminal device may present the second target interface returned by the second server to the user, for the user to browse the item information the user is interested in.

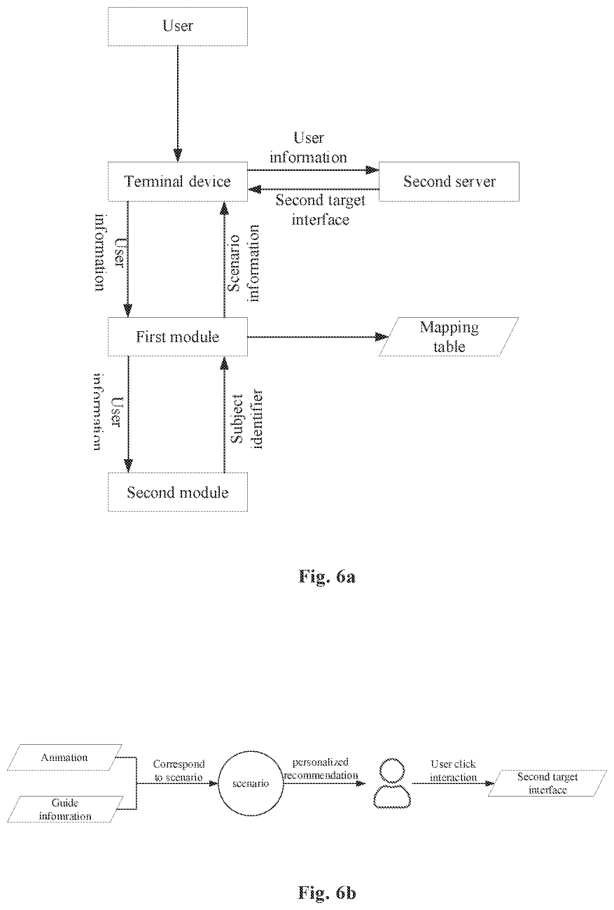

Further referring to FIG. 6a, FIG. 6a is a schematic diagram of an information flowing process of the system shown in this embodiment. Here, the first server may include a first module and a second module. The first module may store a mapping table for representing a corresponding relationship between a subject and a scenario. A terminal device currently presents a first target interface on which target information is displayed. As shown in FIG. 6a, a user may trigger the target information displayed on the first target interface, to cause the terminal device to send the user information of the user to the first module. Then, the first module may forward the user information to the second module. Thereafter, the second module may perform corresponding information processing based on the user information to obtain a subject identifier of a target subject related to an item preferred by the user, and send the subject identifier to the first module. Next, the first module may determine a target scenario based on the subject identifier and the stored mapping table, generate scenario information including an animation corresponding to the subject identifier and guide information corresponding to the target scenario, and send the scenario information to the terminal device. The terminal device may then present the scenario information on the first target interface. Thereafter, if the user is interested in the scenario information, the user may trigger the scenario information on the first target interface, to cause the terminal device to send the user information to the second server. Then, the second server may perform corresponding information processing based on the user information to generate a second target interface, and return the second target interface to the terminal device. Finally, the terminal device may present the second target interface.

Further referring to FIG. 6b, FIG. 6b is a schematic diagram of a product form of the system shown in this embodiment. The product form of the system may be as shown in FIG. 6b, one scenario may correspond to one animation and one piece of guide information, and the scenario may be acquired according to a personalized recommendation to a user. Here, the user may perform a click interaction on the recommended scenario information. When clicking on the scenario information, the user would enter the corresponding second target interface.

It can be seen from FIG. 5 that, as compared with the embodiment corresponding to FIG. 2, the system provided in this embodiment emphasizes the following steps. The terminal device sends, in response to the triggering operation of the user on the scenario information, the second target interface acquisition request including the user information to the second server. Then, the second server acquires the item information of the item preferred by the user and related to the at least one item category corresponding to the scenario information based on the user information, generates the second target interface based on the acquired item information, and returns the second target interface to the terminal device. Then, the terminal device presents the second target interface to the user. Thus, according to the scheme described in this embodiment, it is possible to further implement that the information is pushed with pertinence and that the personalized high-quality item and content are precisely recommended to the user, thereby satisfying the personalized demands of different users.

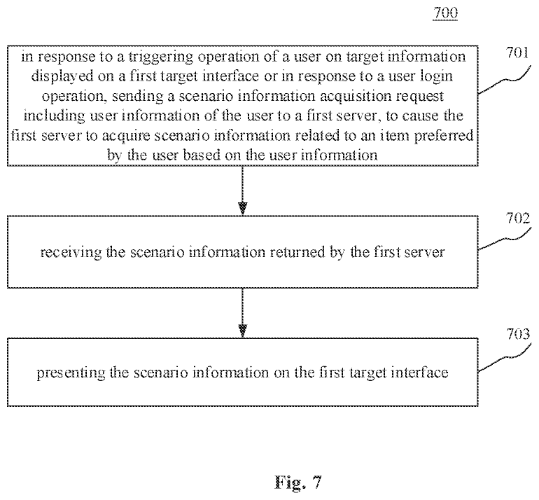

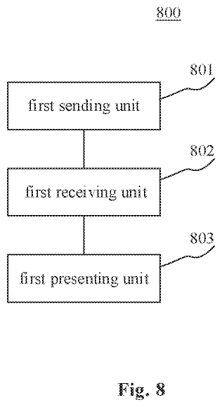

Further referring to FIG. 7, FIG. 7 illustrates a flow 700 of an embodiment of a method for presenting information according to the present disclosure. The flow 700 of the method for presenting information includes the following steps:

In step 701, in response a triggering operation of a user on target information displayed on a first target interface or in response to a user login operation, a scenario information acquisition request including user information of the user is sent to a first server, to cause the first server to acquire scenario information related to an item preferred by the user based on the user information.

In this embodiment, an executing body of the method for presenting information may be a terminal device (e.g., the terminal devices 101, 102 and 103 shown in FIG. 1). The terminal device may send, in response to the triggering operation of the user on the target information displayed on the first target interface or in response to a user login operation, the scenario information acquisition request including the user information of the user to the first server (e.g., the first server 105 shown in FIG. 1), to cause the first server to acquire the scenario information related to the item preferred by the user based on the user information. Here, for the explanation of the operation performed by the first server, reference may be made to the relative description of step 202 in the embodiment shown in FIG. 2, which will not be repeatedly described here.

Here, the first target interface may be, for example, the home page of a specified shopping website or shopping application. The first target interface may present many kinds of information, for example, item information, promotion information related to an item, and logo information of a website or client application to which the first target interface belongs. The target information may be any one of the many kinds of information. Here, the logo information may be used to represent the website or client application to which the first target interface belongs. The logo information may include, for example, an image and/or a text.

In this embodiment, the triggering operation of the user on the target information may be a mouse hover operation, a single-click operation, a double-click operation, a sliding operation, or the like. The user information may include, for example, basic information of the user, and the basic information may include, but not limited to, the identifier, the age, the gender, etc. of the user.

In some implementations of this embodiment, the user login operation includes: the user logging into an application, the user logging into a webpage, or jumping to a target page.

Here, the scenario information requested by the scenario information acquisition request may be the scenario information determined according to the item preferred by the user. In addition, the scenario information may be triggerable information. Further, the scenario information may be information triggerable and having a dynamic effect. The scenario information may include, for example, at least one of an animation or guide information. In addition, for example, the scenario indicated by the scenario information may include, but not limited to, sports, gifted children, examination necessities, online learning, and the like.

The scenario may be pre-determined by clustering a large number of items. The scenario may correspond to guide information and at least one item category. The guide information may be used to guide the user to enter, by triggering the scenario information, a second target interface for displaying item information of an item that is under at least one item category corresponding to a scenario indicated by triggered scenario information and that is preferred by the user. For example, the second target interface may be referred to as a treasure hunt channel or a treasure hunt interface. It should be noted that the at least one item category corresponding to the scenario may be a category of a specified level (e.g., a third level). For example, a shuttlecock, a football, sports shoes, etc, under the category of the third level may be classified into the sports scenario. As another example, the following categories of the third level may be classified into the gifted children scenario: study room supplies/stationery, children literature, student stationery, a popular science encyclopedia, a children study table/chair, a smart watch, a picture book, and a desk lamp.

In step 702, the scenario information returned by the first server is received.

In this embodiment, the terminal device may receive, by means of a wired connection or a wireless connection, the scenario information returned by the first server.

In some implementations of this embodiment, the terminal is configured to acquire the scenario information and store the scenario information in a cache in response to the user login operation.

In step 703, the scenario information is presented on the first target interface.

In this embodiment, after receiving the scenario information returned by the first server, the terminal device may present the received scenario information on the first target interface. Here, for example, the terminal device may present the scenario information at any presentation position on the first target interface. Alternatively, the terminal device may also present the scenario information at a presentation position where the triggered target information is located.

In some alternative implementations of this embodiment, the scenario indicated by the scenario information may correspond to the at least one item category. The terminal device may further send, in response to a triggering operation of the user on the scenario information, a second target interface acquisition request including the user information to a second server, such that the second server acquires item information of an item preferred by the user and related to the at least one item category based on the user information, and generates a second target interface based on the acquired item information. The terminal device may receive the second target interface returned by the second server and present the second target interface to the user. Here, for the explanation of this implementation, reference may be made to the relative descriptions of steps 504-507 in the embodiment shown in FIG. 5, which will not be repeatedly described here.

In some alternative implementations of this embodiment, the scenario information may include the animation and Guide information related to the scenario indicated by the scenario information. In addition, each scenario may correspond a subject identifier in advance. The subject identifier may correspond to an animation and at least one scenario. The animation related to the scenario may be an animation corresponding to a subject identifier correspond in to the scenario. It should be noted that the subject indicated by the subject identifier may be obtained by clustering a plurality of scenarios.

In some alternative implementations of this embodiment, the target information may be the logo information of the website or client application to which the first target interface belongs. The animation may be generated based on an image related to the logo information. It should be noted that, by presenting, in response to a triggering operation of the user on the logo information, corresponding scenario information including the animation generated based on the image related to the logo information to the user, a logo image may be dynamized and personalized on the basis that the high-quality item and content are precisely recommended in combination with the personalized demand of the user. The logo image may be vividly and stereoscopically presented to the user by means of a specified interaction. In this way, the interest of the user in access may promoted and the pleasure and curiosity in shopping may be increased, which helps to increase the number of users.

In some optional implementations of this embodiment, the terminal is configured so present the scenario information in the cache on the first target interface in response to a trigger operation of the user on the target information.

In some optional implementations of this embodiment, the terminal is configured to present the scenario a information around the target information in response to no information being presented around the target information.

According to the method provided in the above embodiment of the present disclosure, in response to the triggering operation of the user on the target information displayed on the first target interface, the scenario information acquisition request including the user information of the user is sent to the first server, to cause the first server to acquire the scenario information related to the item preferred by the user based on the user information. Thus, the scenario information returned by the first server is received, and the scenario information is presented on the first target interface. According to the scheme described in the embodiment of the present disclosure, the scenario information the user is interested in may be recommended by mining the interest of the user, thereby implementing that the information is pushed with pertinence. In addition, by presenting the scenario information, the interest of the user in access may be promoted, which helps to increase the number of users.

Further referring to FIG. 8, as an implementation of the method shown in the above drawings, the present disclosure provides an embodiment of an apparatus for presenting information. The embodiment or the apparatus corresponds to the embodiment of she method shown in FIG. 7. The apparatus may be applied in various electronic devices.

As shown in FIG. 8, the apparatus 800 for presenting information in this embodiment includes: a first sending unit 801, configured to send, in response to a triggering operation of a user on target information displayed on a first target interface or in response to a user login operation, a scenario information acquisition request including user information of the user to a first server, to cause the first server to acquire scenario information related to an item preferred by the user based on the user information; a first receiving unit 802, configured to receive the scenario information returned by the first server; and a first presenting unit 803, configured to present the scenario information on the first target interface.

In this embodiment, for specific processes of the first sending unit 801, the first receiving unit 802 and the first presenting unit 803 in the apparatus 800 for presenting information, and their technical effects, reference may be respectively made to relative descriptions of step 701, step 702 and step 703 in the corresponding embodiment of FIG. 7, which will not be repeatedly described here.

In some alternative implementations of this embodiment, a scenario indicated by the scenario information corresponds to at least one item category. The apparatus 800 may further include: a second sending unit (not shown), configured to send, in response to a triggering operation of the user on the scenario information, a second target interface acquisition request including the user information to a second server, to cause the second server to acquire item information of an item preferred by the user and related to the at least one item category based on the user information, and generate a second target interface based on the acquired item information; a second receiving unit (not shown), configured to receive the second target interface returned by the second server; and a second presenting unit (not shown), configured to present the second interface to the user.

In some alternative implementations of this embodiment, the scenario information may include an animation and guide information related to the scenario indicated by the scenario information.

In some alternative implementations of this embodiment, the target information may be logo information of a client application to which the first target interface belongs, and the animation is generated based on an image related to the logo information.

In some alternative implementations of this embodiment, the first presenting unit 803 may be further configured to: present the scenario information at a presentation position where the target information is located.

According to the apparatus provided in the above embodiment of the present disclosure, in response to the triggering operation of the user on the target information displayed on the first target interface or in response to a user login operation, the scenario information acquisition request including the user information or the user is sent to the first server, to cause the first server to acquire the scenario information related to the item preferred by the user based on the user information. Thus, the scenario information returned by the first server is received, and the scenario information is presented on the first target interface. According to the scheme described in the embodiment of the present disclosure, the scenario information the user is interested in may be recommended by mining the interest of the user, thereby implementing that the information is pushed with pertinence. In addition, by presenting the scenario information, the interest of the user in access may be promoted, which helps to increase the number of users.

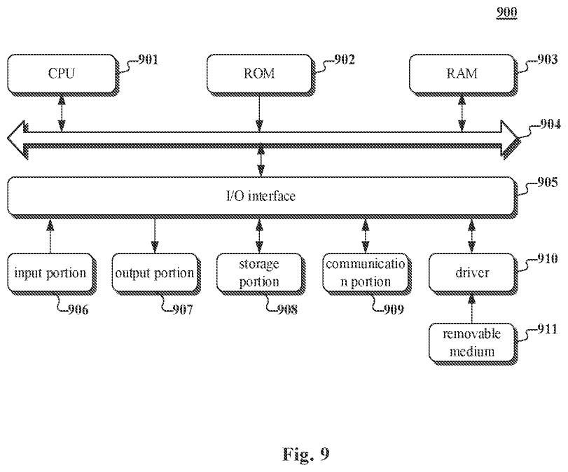

Referring to FIG. 9, FIG. 9 is a schematic structural diagram of a computer system 900 of an electronic device (e.g., the terminal devices 101, 102 and 103 shown in FIG. 1) adapted to implement the embodiments of the present disclosure. The electronic device shown in FIG. 9 is merely an example, and should not bring any limitation. to the functions and the scope of use of the embodiments of the present disclosure.

As shown in FIG. 9, the computer system 900 includes a central processing unit (CPU) 901, which may execute various appropriate actions and processes in accordance with a program stored in a read-only memory (ROM) 902 or a program loaded into a random access memory (RAM) 903 from a storage portion 908. The RAM 903 further stores various programs and data required by operations of the system 900. The CPU 901, the ROM 902 and the RAM 903 are connected to each other through a bus 904. An input/output (I/C)) interface 905 is also connected to the bus 904.

The following components are connected to the I/O interface 905: an input portion 906 including a keyboard, a mouse etc.; an output portion 907 including a cathode ray tube (CRT) , a liquid crystal display device (LCD), a speaker etc.; a storage portion 908 including a hard disk and the like; and a communication portion 909 including a network interface card, such as a LAN card and a modem. The communication portion 909 performs communication processes via a network, such as the Internet. A driver 910 is also connected to the I/O interface 905 as required. A removable medium 911, such as a magnetic disk, an optical disk, a magneto-optical disk, and a semiconductor memory, may be installed on the driver 910, to facilitate the retrieval of a computer program from the removable medium 911, and the installation thereof on the storage portion 908 as needed.

In particular, according to embodiments of the present disclosure, the process described above with reference to the flow chart may be implemented in a computer software program. For example, an embodiment of the present disclosure includes a computer program product, which comprises a computer program that is tangibly embedded in a machine-readable medium. The computer program includes program codes for executing the method as illustrated in the flow chart. In such an embodiment, the computer program may be downloaded and installed from a network via the communication portion 909, and/or may be installed from the removable media 911. The computer program, when executed by the central processing unit (CP) 901, implements the above mentioned functionalities as defined by the methods of the present disclosure.

It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM) , an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. In the present disclosure, the computer readables final medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

A computer program code for executing operations in the disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions it should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The described units involved in the embodiments of the present disclosure may be implemented by means of software or hardware. The described units may also be provided in a processor. For example, the processor may be described as: a processor including a first sending unit, a first receiving unit and a first presenting unit. Here, the names of these units do not in some cases constitute a limitation to such units themselves. For example, the first sending unit may alternatively be described as “a unit for sending a scenario information acquisition request including user information of a user to a first server.”

In another aspect, the present disclosure further provides a computer readable medium. The computer readable medium may be the computer readable medium included in the electronic device described in the above embodiments, or a stand-alone computer readable medium not assembled into the electronic device. The above computer readable medium carries one or more programs. The one or more programs, when executed by the electronic device, cause the electronic device to: send, in response to a triggering operation of a user on target information displayed on a first target interface, a scenario information acquisition request including user information of the user to a first server, to cause the first server to acquire scenario information related to an item preferred by the user based on the user information; receive the scenario information returned by the first server; and present the scenario information on the first target interface.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

1. A system for presenting information, comprising a terminal device and a first server,
wherein the terminal device is configured to send, in response to a triggering operation of a user on target information displayed on a first target interface or in response to a login operation of the user, a scenario information acquisition request including user information of the user to the first server,
the first server is configured to acquire scenario information related to an item preferred by the user based on the user information, and return the scenario information to the terminal device, and
the terminal device is further configured to present the scenario information on the first target interface.

2. The system according to claim 1, wherein a scenario indicated by the scenario information corresponds to at least one item category, and the system further comprises a second server,
the terminal device is further configured to send, in response to a triggering operation of the user on the scenario information, a second target interface acquisition request including the user information to the second server,
the second server is configured to acquire item information of an item preferred 1w the user and related to the at least one item category based on the user information, generate a second target interface based on the acquired item information, and return the second target interface to the terminal device, and
the terminal device is further configured to present the second target interface to the user.

3. The system according to claim 1, wherein the scenario information comprises a first animation and first guide information related to the scenario indicated by the scenario information.

4. The system according to claim 3, wherein the target information is logo information of a website or client application to which the first target interface belongs, and the animation is generated based on an image related to the logo information.

5. The system according to claim 4, wherein the terminal device is further configured to:
present the scenario information at a presentation position where the target information is located.

6. The system according to claim 3, wherein the first server is further configured to:
acquire historical behavior data of the user based on the user information;
select an item identifier from a preset item identifier set based on the historical behavior data, to generate an item identifier group, wherein an item identifier in the item identifier set corresponds to a subject identifier, the subject identifier corresponds to a second animation and at least one scenario, and each scenario in the at least one scenario corresponds to second guide information;
select, from the subject identifier corresponding to the item identifier in the item identifier group; a subject identifier as a target subject identifier;
select, from at least one scenario corresponding to the target subject identifier, a scenario as a target scenario; and
generate information including the second animation corresponding to the target subject identifier and the second guide information corresponding to the target scenario as the scenario information including the first animation and the first guide information.

7. The system according to claim 6, wherein the historical behavior data comprises at least one item identifier, and the item identifier in the at least one item identifier corresponds to a frequency,
wherein the first server is further configured to:
select an item identifier associated with the at least one item identifier from the item identifier set as a candidate item identifier, to generate a candidate item identifier set; and
select a candidate item identifier satisfying a preset selection condition from the candidate item identifier set, to generate the item identifier group, the selection condition comprising at least one of: the item identifier being not included in a first item identifier set, or a frequency corresponding to the item identifier being not higher than a frequency threshold, wherein an item indicated by a first item identifier in the first item identifier set is an item prohibited from being presented.

8. The system according to claim 7, wherein the first server is further configured to:
determine a degree of preference of the user for an item indicated by the candidate item identifier in the candidate item identifier set based on the at least one item identifier, after generating the candidate item identifier set; and
use a subject identifier corresponding to an item identifier corresponding to a maximum degree of preference in the item identifier group as the target subject identifier, after generating the item identifier group.

9. The system according to claim 2, wherein the second server is further configured to:
acquire a user preference model pre-established for the user based on the user information, the user preference model comprising an item identifier of the item preferred by the user;
extract an item identifier related to the at least one item category from the user preference model; and
acquire item information of an item indicated by the extracted item identifier.

10. The system according to claim 2, wherein the second server is further configured to:
generate an item information set based on the acquired item information;
acquire associated information of item information in the item information set;
sort pieces of the item information in the item information set based on the acquired associated information, to obtain an item information sequence; and
generate the second target interface based on the item information sequence.

11. The system according to claim 1, wherein the trigger operation comprises a mouse hovering operation, a single-click operation, a double-click operation, or a sliding operation.

12. The system according to claim 1, wherein the target information comprises text or icons.

13. The system according to claim 1, wherein the target information comprises an image mark presenting a target object, the scenario information comprises animation and guideline information, and at least one frame of image in the animation presents the target object, where the scenario information is triggerable information and after the scenario information is triggered, the second target interface is presented, the second target interface presenting the item information of the item preferred by the user.

14. The system according to claim 1, wherein the terminal device is configured to present the scenario information around the target information in response to no information being presented around the target information.

15. The system according to claim 1, the terminal is configured to: in response to the user login operation, acquire the scenario information and store the scenario information in a cache; and in response to the user trigger operation on the target information, present the scenario information in the cache on the first target interface.

16. A method for presenting information, applied to a terminal device, wherein the method comprises:
sending, in response to a triggering operation of a user on target information displayed on a first target interface or in response to a user login operation, a scenario information acquisition request including user information of the user to a first server, to cause the first server to acquire scenario information related to an item preferred by the user based on the user information;
receiving the scenario information returned by the first server; and
presenting the scenario information on the first target interface.

17. The method according to claim 16, wherein a scenario indicated by the scenario information corresponds to at least one item category, and
the method further comprises:
sending, in response to a triggering operation of the user for the scenario information, a second target interface acquisition request including the user information to a second server, to cause the second server to acquire item information of an item preferred by the user and related to the at least one item category based on the user information, and generate a second target interface based on the acquired item information;
receiving the second target interface returned by the second server; and
presenting the second target interface to the user.

18. The method according to claim 16, wherein the scenario information comprises an animation and guide information related to the scenario indicated by the scenario information.

19-32. (canceled)

33. An electronic device comprising:
one or more processors; and
a storage apparatus, configured to store one or more programs,
wherein the one or more programs, when executed by the one or more processors, cause the one or more processors to perform operations comprising:
sending, in response to a triggering operation of a user on target information displayed on a first target interface or in response to a user login operation, a scenario information acquisition request including user information of the user to a first server, to cause the first server to acquire scenario information related to an item preferred by the user based on the user information;
receiving the scenario information returned by the first server; and
presenting the scenario information on the first target interface.

34. A non-transitory computer readable medium, storing a computer program, wherein the program, when executed by a processor, implements the method according to claim 16.
